(19) United States
(12) Patent Application Publication
(10) Pub. No.: US 2016/0335864 A1
(43) Pub. Date: Nov. 17, 2016

(54) THEFT-DETERRENT TAG

(71) Applicant: USS Technologies, LLC, Rancho Cucamonga, CA (US)

(72) Inventors: Adel O. Sayegh, Rancho Cucamonga, CA (US); Edgardo M. Redublo, Rancho Cucamonga, CA (US); Anthony Oliver, Rancho Cucamonga, CA (US); Marc Trincale, Rancho Cucamonga, CA (US); Xiaofeng Rao, Hangzhou (CN); Jimin Xi, Hangzhou (CN)

(21) Appl. No.: 14/714,202

(22) Filed: May 15, 2015

(51) Int. Cl. G08B 13/24

(52) U.S. Cl. CPC G08B 13/2431; G08B 13/2434

(57) ABSTRACT

The present invention discloses a theft-deterrent tag, comprising a tag body that accommodates a movable member, and a securing member that has a first end associated with the movable member, and a second end that is movably associated with the tag body. When the securing member experiences torsion force, the movable member moves to allow the first end of the securing member to revolve around rotating second end.

### CROSS-REFERENCE TO RELATED APPLICATIONS

This Application claims the benefit of priority of co-pending U.S. Utility Provisional Patent Application No. 61/994,067, filed on May 15, 2014, the entire disclosure of which is expressly incorporated by reference herein.

It should be noted that where a definition or use of a term in the incorporated patent application is inconsistent or contrary to the definition of that term provided herein, the definition of that term provided herein applies and the definition of that term in the incorporated patent application does not apply.

### BACKGROUND OF THE INVENTION

1. Field of the Invention

One or more embodiments of the present invention relate to a theft-deterrent tag and, more particularly, to a theft-deterrent tag that is tamper resistant and difficult to defeat.

2. Description of Related Art

Theft-deterrent tags are well known and have been in use for a number of years. Regrettably, most are easily tampered with and defeated by simple tools. In general, a lanyard of conventional tags has a first end that is generally connected to a body of the tag at a first fixed, immovable position while a second end of the lanyard is passed through and engages an article, looping back and detachably connecting to a second fixed, immovable position on the body of the tag. In most cases, the tag may be breached by insertion of a lever through the lanyard loop, the lever rotated until the lanyard or the tag body fails. In other words, a tag attached to the article may be simply twisted until the lanyard breaks or a pin of the lanyard is forced out of a clutch, which disengages the article.

Accordingly, in light of the current state of the art and the drawbacks to current theft-deterrent tags, there remains a long standing and continuing need for an advance in the art of theft deterrent tags that makes the tags more difficult to defeat, simpler in both design and use, more economical and efficient in their construction and use, and provide a more secure engagement of the article.

### BRIEF SUMMARY OF THE INVENTION

A non-limiting, exemplary aspect of an embodiment of the present invention provides an theft-deterrent tag, comprising:
a tag body;
a movable member; and
a securing member that has a first end coupled with the movable member, and a second end that is movably associated with the tag body;
wherein: when a torsion force is applied to the securing member, the movable member moves to allow the first end of the securing member to revolve around rotating second end to thereby render ineffective the applied torsion force.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1A to 1D are non-limiting, exemplary illustrations of an embodiment of a theft-deterrent tag in accordance with the present invention, with FIG. 1E illustrating sectional view and FIG. 1F an exploded view of theft-deterrent tag illustrated in FIGS. 1A to 1D;

FIGS. 2A to 2F are non-limiting, exemplary illustrations of a first piece in combination with a movable member and a securing member in accordance with one or more embodiments of the present invention; and

FIGS. 3A to 3D are non-limiting, exemplary illustrations of a second piece in combination with an antenna and clutch housing and clutch assembly in accordance with one or more embodiments of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

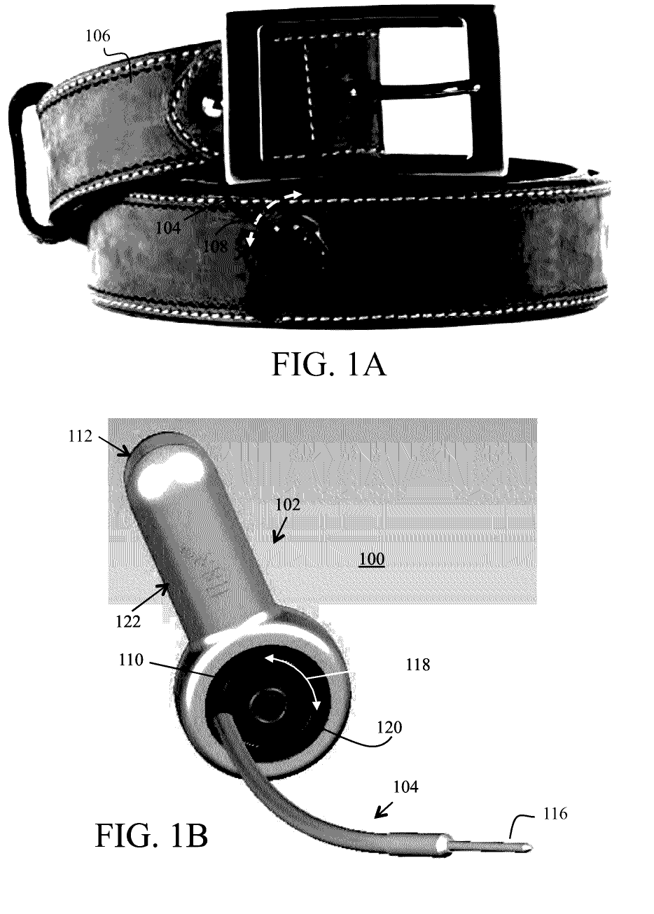

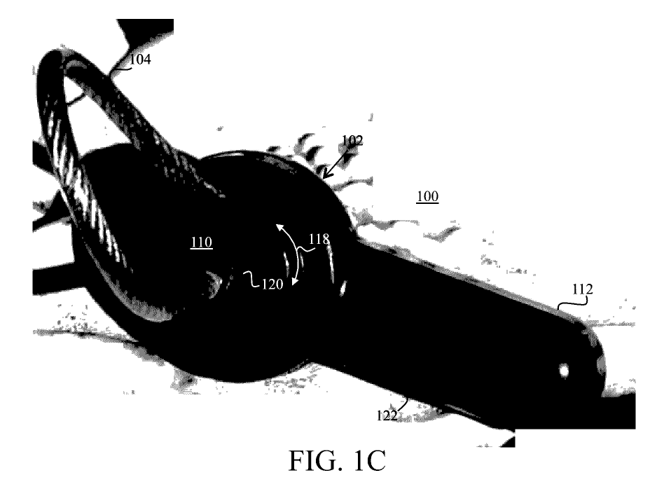

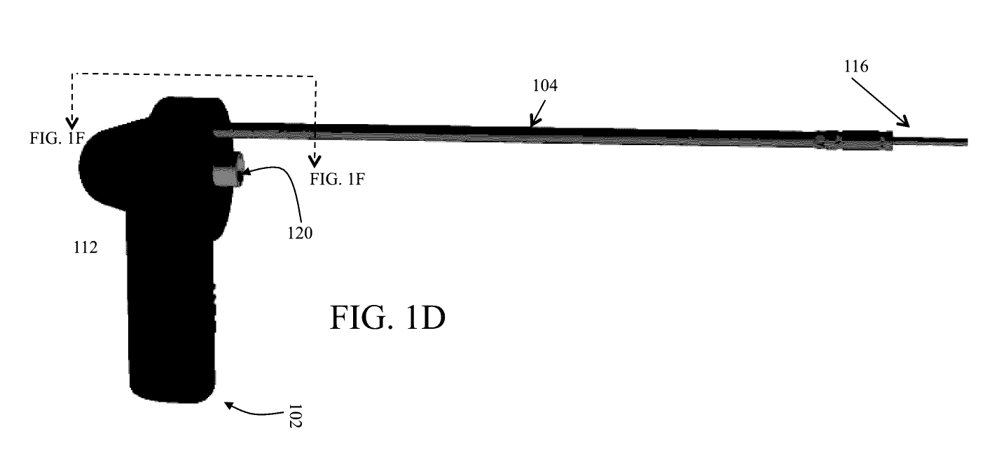

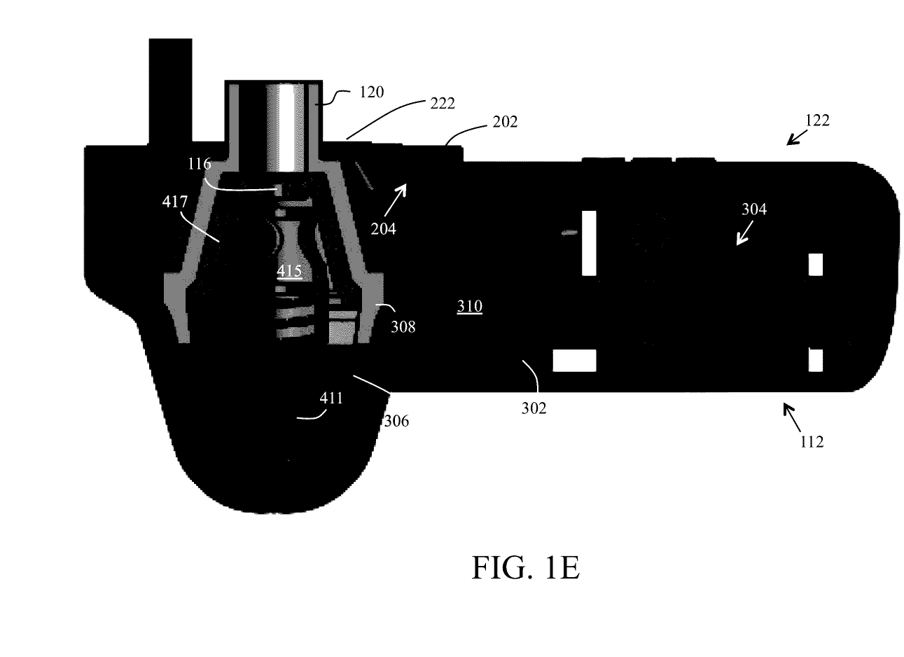

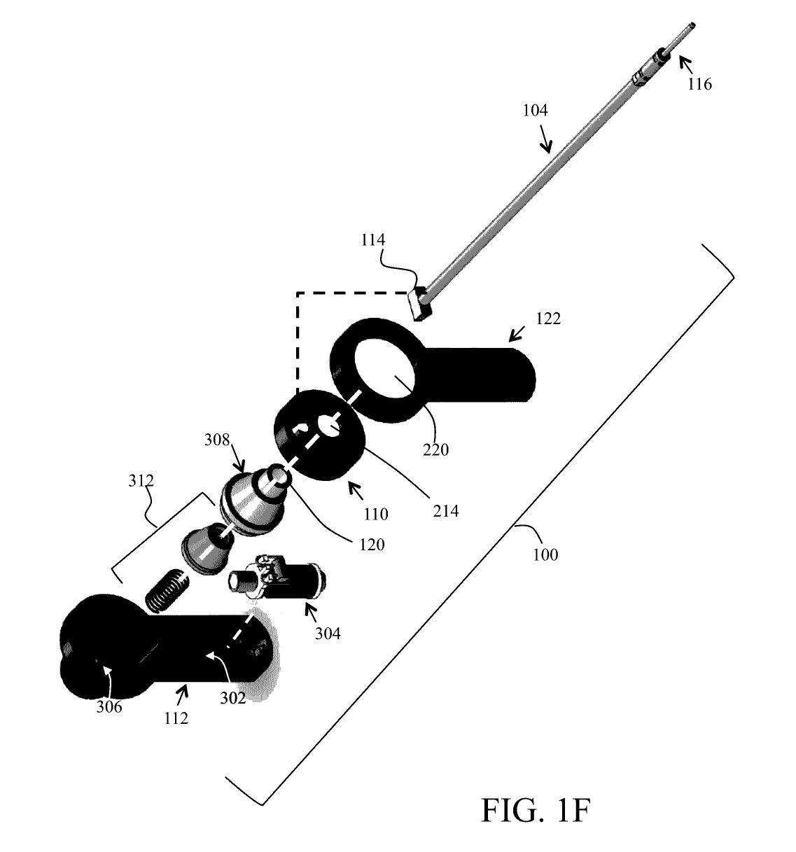

FIGS. 1A to 1D are non-limiting, exemplary illustrations of an embodiment of a theft-deterrent tag in accordance with the present invention, with FIG. 1E illustrating sectional view of theft-deterrent tag illustrated in FIGS. 1A to 1D and FIG. 1F an exploded view thereof. As illustrated, theft-deterrent tag 100 of the present invention includes a tag body 102 and a securing member in a form of an exemplary lanyard 104 that may be used to attach tag 100 to an article 106. Theft deterrent tag 100 includes a movable member 110 that absorbs a torsion force 108 experienced by lanyard 104 when twisted, which prevents damage to tag 100. In particular, theft deterrent tag 100 includes movable member 110, tag body 102, and lanyard 104 that has a first end 114 associated with movable member 110, and a second end 116 that is movably associated with tag body 102. The arrangement enables absorption of torsion force 108 experienced by lanyard 104, whereby twisting of lanyard 104 upon itself is prevented by motion 118 of movable member 110, which prevents tag 100′s defeat. That is, application of torsion force 108 would move member 110 (which would move first end 114 of lanyard 104 associated with moveable member 110) and further, would also move second end 116 of lanyard 104, which is movably associated with tag body 102. In other words, if the movements were a circular motion as exemplarily illustrated, first end 114 would revolve or orbit around clutch port access 120, which in turn, would rotate second end 116 around itself (generally along a portion of a longitudinal axis of lanyard 104 at second end 116) to thereby absorb torsion force 118.

As detailed below, first end 114 of lanyard 104 is coupled with movable member 110 at a fixed position, with second end 116 of lanyard 104 detachably engaged with tab body 102 via a clutch access port 120 and moves freely therein. Stated otherwise, motion 118 of movable member 110 moves first end 114 of lanyard 104, while second end 116 of lanyard 104 continues to freely move within clutch access port 120 while engaged with tag body 102. In the non-limiting, particular instance illustrated, movable member 110 is a swivel that enables a circular motion of lanyard 104 in relation to tag body 102. That is, swivel action 118 of movable member 110 enables revolving of first end 114 of lanyard 104 in relation to tag body 102, while second end 116 of lanyard 104 freely rotates within a clutch housed (or stationary member) 308 within tag body 102. As detailed below, once in an engaged state, first end 114 of lanyard 104 may be unlocked from clutch housing 308 by authorized user using a magnetic detacher, detailed below.

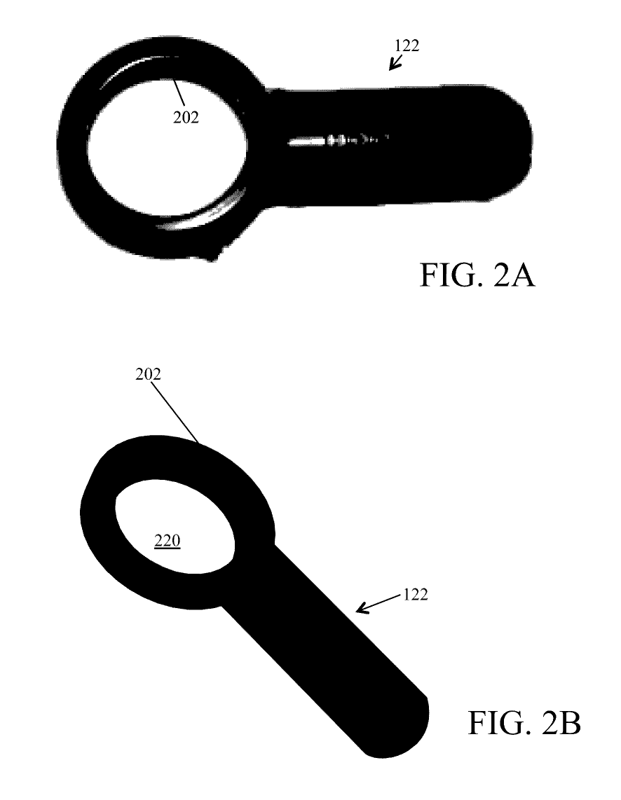

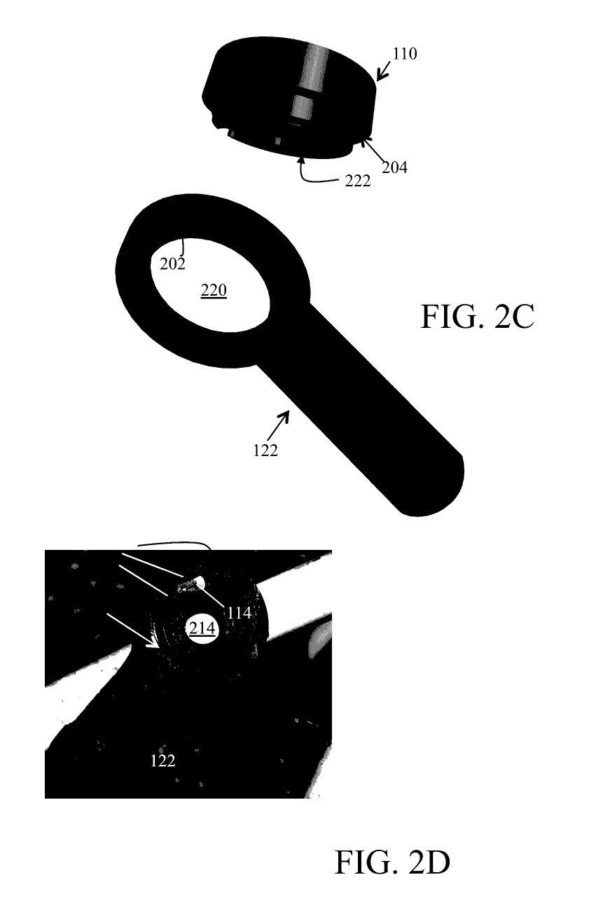

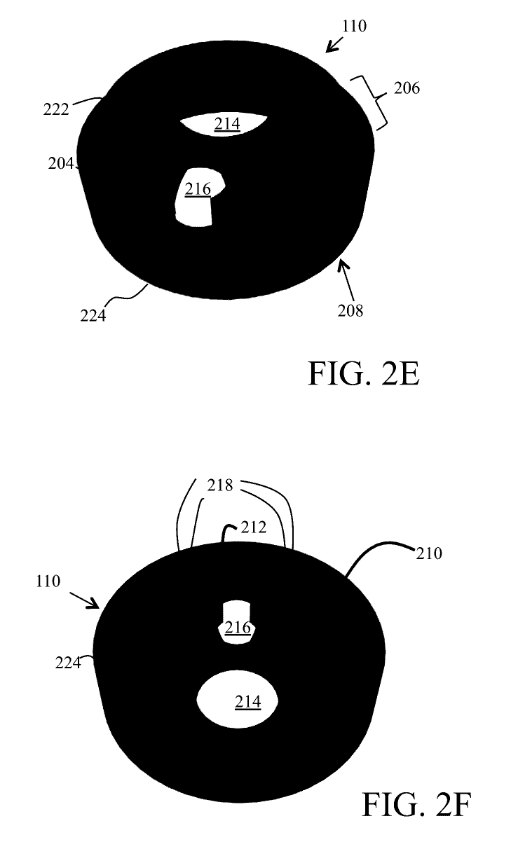

Tag body 102 is comprised of first piece 122 that when combined with a second piece 112 (e.g., by sonic welding) forms a housing that accommodates movable member 110 and a well-known and conventional antenna 304 to form an Electronic Article Surveillance (EAS) tag 100. Non-limiting example of a conventional antenna 304 may comprise of an inductor (L) and capacitor (C) or LC circuit. FIGS. 2A to 2F are non-limiting, exemplary illustrations of a first piece 122 in combination with movable member 110 and lanyard 104 in accordance with one or more embodiments of the present invention. As illustrated in FIGS. 1A to 2F, movable member 110 is positioned between first piece 122 and second piece 112 of tag body 102, with a top side 222 of the movable member 110 generally flush with hole 220 of first piece 122. As best illustrated in FIGS. 2C and 2D, movable member 110 includes interface structure for movably securing movable member 110 with tag body 102. Interface structure includes a rabbet 204 that glidingly engages a flange 202 of tag body 102. More specifically, first piece 122 of tag body 102 has an engagement flange 202 that maintains and securely and fixedly holds moveable member 110 within the housing of tag body 102 in between first and second pieces 122 and 112 when engagement flange 202 rests on rabbet 204 of moveable member 110. Rabbet 204 of movable member 110 freely glides under engagement flange 202 of first piece 122.

As illustrated in FIGS. 2E and 2F, movable member 110 is a single, integral piece comprised of an interface structure 206 that is configured as a disc positioned on top of a base portion 208. The interface structure 206 is generally flush with the hole 220 of the first piece 122. The base portion 208 forms a cylindrical body, with the interface structure 206 and the base portion 208 forming a circular rabbet 204 along a top side 222 of movable member 110 and forming an underside cavity 210. Movable member 110 further includes a compartment 212 for securing first end 114 of lanyard 104 at a fixed (or immovable) position. Movable member 110 also includes an opening 214 for enabling access to an engagement mechanism (e.g., clutch assembly) 312 for detachably engaging second end 116 of lanyard 104 with clutch 312. Compartment 212 has a hole 216 for inserting and passing through second end 116 of lanyard 104 and a set of bracket posts 218 that secure first end 114 of lanyard 104 (also illustrated in FIG. 2D). Bracket posts 218 and compartment 212 in general, are commensurately configured to house a correspondingly shaped first end 114 of the lanyard 104. As illustrated, the compartment 212 is located off-center in relation to a body of movable member 110, enabling first end 114 to revolve or orbit around opening 214.

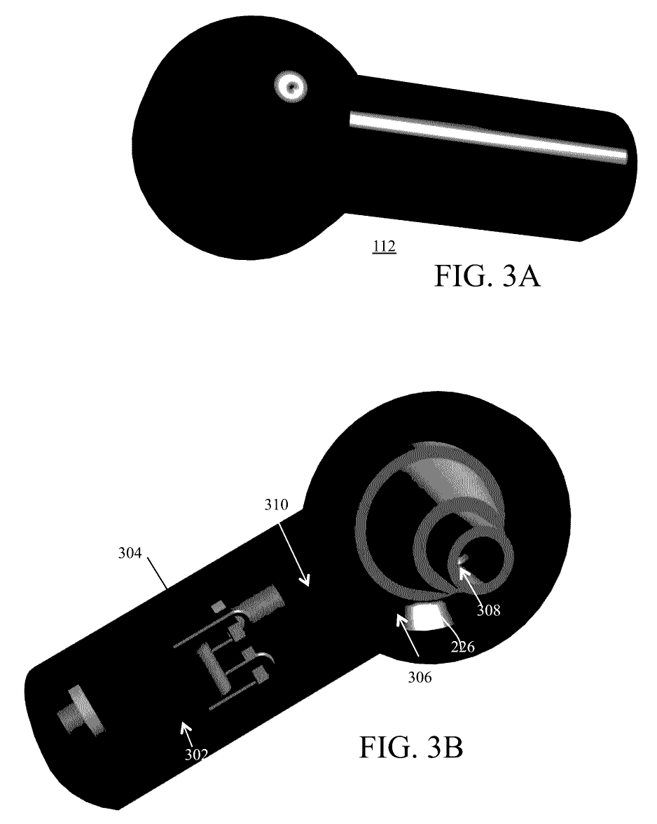

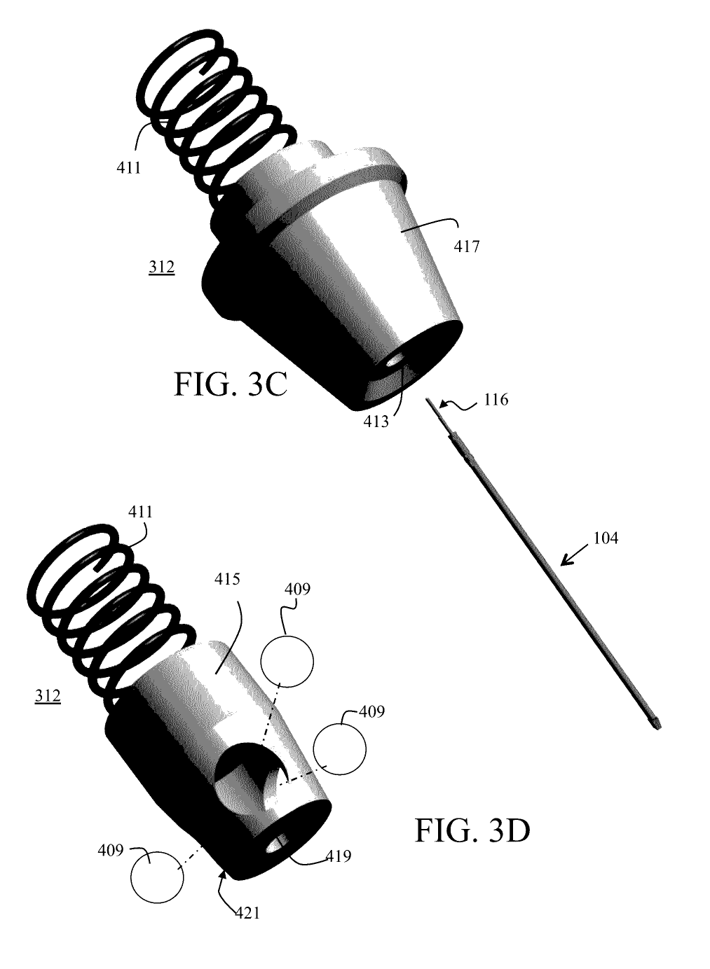

FIGS. 3A and 3B are non-limiting, exemplary illustrations of a second piece of the tag body in accordance with one or more embodiments of the present invention. Second piece 112 has a first cavity section 302 that house antenna 304. Further included is a second cavity section 306 that has clutch housing 308 that houses a well known engagement mechanism in a form of clutch assembly 312 and receives movable member 110. As best illustrated in FIGS. 3C and 3D, in this non-limiting, exemplary instance, clutch assembly 312 is comprised of metal pieces 409 (in non-limiting exemplary form of ball bearings 409) that are biased towards a narrow end 421 of metal cylinder 415 by biasing mechanism 411, with metal pieces 409 and metal cylinder 415 held together within metal cover 417. When second end 116 of securing member 104 is inserted through hole 413 within metal cover 417 and further within metal cylinder 415 through hole 419, metal pieces 409 are continued to be pushed towards the second end 116 by the spring 411, maintaining a strong, axial frictional hold on second end 116 that prevents second end 116 from being moved axially (pulled out) while enable second end 116 to have a to rotate while in between ball bearing 409. This way, when securing member 104 experiences torsion attack, first end 114 is revolved around clutch assembly 312 due to moveable member 110, which enables second end 116 to rotate within clutch assembly 312 while fully engaged and locked therein and not able to be removed or pulled out axially.

To release and unlock second end 116 of securing member 104 (pull it out axially from clutch assembly 312), EAS tag 100 is brought into contact with a well known magnetic detacher, which pulls and moves metal pieces 409 away from narrow end 421 of metal cylinder 415 against the biases of spring 411, reduce the frictional grip of metal pieces 409 with second end 116 to enable removal thereof from clutch assembly 312.

As further illustrated, a lower edge 224 of base portion 208 of movable member 110 rests on a surface 226 of second cavity section 306. An elongated post 310 is provided that isolates antenna 304 from interfering with mechanical motion 118 of movable member 110, and further, provides structural supporting contact point between the first and the second pieces 122 and 112.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A theft-deterrent tag, comprising:
a tag body;
a movable member; and
a securing member that has a first end associated with the movable member, and a second end that is movably associated with the tag body.

2. The theft-deterrent tag as set forth in claim 1, wherein:
the first end of the securing member is coupled with the movable member at a fixed position; and
the second end of the securing member is detachable engaged with the tag body and moves freely while engaged with the tag body.

3. The theft-deterrent tag as set forth in claim 1, wherein:
a motion of the movable member moves the first end of the securing member, while the second end of the securing member continues to freely move while engaged with the tag body.

4. The theft-deterrent tag as set forth in claim 1, wherein:
the movable member includes:
an accommodation for securing the first end of the securing member at a fixed position; and
an opening for enabling access to a stationary member.

5. The theft-deterrent tag as set forth in claim 1, wherein:
the movable member includes:
interface structure for movably securing the movable member with the tag body.

6. The theft-deterrent tag as set forth in claim 5, wherein:
the interface structure includes a rabbet that glidingly engages a flange of the tag body.

7. The theft-deterrent tag as set forth in claim 1, wherein:
the movable member is positioned between a first piece and a second piece of the tag body.

8. The theft-deterrent tag as set forth in claim 7, wherein:
the first piece has an engagement flange that maintains and securely holds the moveable member within a housing of the tag body in between the first and the second pieces when the engagement flange rests on a rabbet of the moveable member.

9. The theft-deterrent tag as set forth in claim 8, wherein:
the rabbet of the movable member freely glides under the engagement flange of the first piece.

10. The theft-deterrent tag as set forth in claim 1, wherein:
the movable member is a swivel that enables a rotation of the securing member in relation to the stationary member.

11. The theft-deterrent tag as set forth in claim 1, wherein:
the movable member is a swivel that enables revolving of the first end of the securing member in relation to the stationary member, while the second end of the securing member freely rotates while engaged with the stationary member.

12. The theft-deterrent tag as set forth in claim 1, wherein:
the moveable member is comprised of:
a compartment that houses the first end and has a hole for inserting and passing through the securing member;
the compartment is commensurately configured to house a correspondingly shaped first end of the securing member;
the compartment is located off-center in relation to a body of the movable member.

13. The theft-deterrent tag as set forth in claim 1, wherein:
the movable member is a single, integral piece comprised of an interface structure that is configured as a disc positioned on top of a base portion that is formed as cylindrical body, with the interface structure and the base portion forming a circular rabbet along a top side of the movable member and forming an underside cavity.

14. The theft-deterrent tag as set forth in claim 1, wherein:
the stationary member is an engagement mechanism in a form of a clutch assembly for retaining a second end of securing member.

15. The theft-deterrent tag as set forth in claim 1, wherein:
the second piece has:
a first cavity section that house an antenna;
a second cavity section that accommodates a compartment for housing an engagement mechanism and receives the movable member;
an elongated post that isolates the antenna from interfering with a mechanical motion of the movable member, and further, provides structural supporting contact point between the first and the second stationary pieces.

16. A theft-deterrent tag, comprising:
a tag body;
a movable member; and
a securing member that has a first end coupled with the movable member, and a second end that is movably associated with the tag body;
wherein: when a torsion force is applied to the securing member, the movable member moves to allow the first end of the securing member to revolve around rotating second end.

17. The theft-deterrent tag as set forth in claim 16, wherein:
the securing member is a lanyard.

18. The theft-deterrent tag as set forth in claim 16, wherein:
the second end is movably engaged with an engagement mechanism.

19. The theft-deterrent tag as set forth in claim 18, wherein:
the engagement mechanism is a clutch assembly.

20. A method of neutralizing torsion force applied against a looped securing member, comprising:
revolving a first end of the securing member around a rotating second end using the applied torsion force.
